(19) United States
(12) Patent Application Publication
(10) Pub. No.: US 2026/0162219 A1
(43) Pub. Date: Jun. 11, 2026

(54) METHOD OF IMAGE DISPLAY AND DISPLAY SYSTEM

(71) Applicants: BEIJING BOE DISPLAY TECHNOLOGY CO., LTD., Beijing (CN); BOE Technology Group Co., Ltd., Beijing (CN)

(72) Inventors: Chao Zheng, Beijing (CN); Lili Chen, Beijing (CN); Chaoquan Yao, Beijing (CN); Wenyu Li, Beijing (CN); Jinghua Miao, Beijing (CN); Qingwen Fan, Beijing (CN); Shuai Hao, Beijing (CN); Hao Zhang, Beijing (CN)

(73) Assignees: BEIJING BOE DISPLAY TECHNOLOGY CO., LTD., Beijing (CN); BOE Technology Group Co., Ltd., Beijing (CN)

(21) Appl. No.: 18/704,620

(22) PCT Filed: Jul. 10, 2023
(86) PCT No.: PCT/CN2023/106464

§ 371 Date: Apr. 25, 2024

(51) Int. Cl. G06T 3/4053; G06F 3/01; G06T 11/60

(52) U.S. Cl. CPC G06T 3/4053; G06F 3/013; G06T 11/60; G06T 2210/36

(57) ABSTRACT

A method of image display is provided. The method of image display includes tracking, by a terminal device, an eye movement of a user and obtaining eye tracking data; transmitting the eye tracking data from the terminal device to a content server; determining, by the content server, a dynamic high-resolution region of an original image based on the eye tracking data; rendering, by the content server, a first image having a first resolution; rendering, by the content server, a second image having a second resolution based on the dynamic high-resolution region; encoding, by the content server, the second image having the second resolution, the first image having the first resolution, and parameter data in data streams; and transmitting the data streams from the content server to the terminal device for image display. The second resolution is greater than the first resolution.

### TECHNICAL FIELD

The present invention relates to display technology, more particularly, to a method of image display and a display system.

### BACKGROUND

Real-Time Communication transmission refers to the use of real-time communication technology for data transmission. Compared to traditional video network transmission technologies, it offers lower latency and higher interactivity. RTC transmission optimizes network transfer speed, latency, and bandwidth in real-time, resulting in improvements in real-time performance, stability, and audiovisual quality. As a result, RTC live streaming is better suited for interactive live broadcasts, online education, remote healthcare, online conferences, and other scenarios, making it highly applicable in various fields.

Eye tracking technology is a biometric recognition technology that utilizes the recognition of eye movement patterns to achieve various applications such as identity authentication, emotion analysis, and gaze tracking. Meanwhile, network transmission technology is an essential component of modern information technology development. However, there are currently issues with low transmission efficiency and poor transmission stability. In order to address these problems, this patent proposes a partition-based transmission system with dynamic expansion for load balancing.

### SUMMARY

In one aspect, the present disclosure provides a method of image display, comprising tracking, by a terminal device, an eye movement of a user and obtaining eye tracking data; transmitting the eye tracking data from the terminal device to a content server; determining, by the content server, a dynamic high-resolution region of an original image based on the eye tracking data; rendering, by the content server, a first image having a first resolution, wherein the first image is a full low-resolution rendering of the original image; rendering, by the content server, a second image having a second resolution based on the dynamic high-resolution region, wherein the second image is a high-resolution rendering of a region of the original image; encoding, by the content server, the second image having the second resolution, the first image having the first resolution, and parameter data in data streams; and transmitting the data streams from the content server to the terminal device for image display; wherein second resolution is greater than the first resolution.

Optionally, the method further comprises obtaining, by the terminal device, an updated real time eye tracking coordinate; cropping, by the terminal device, the second image having the second resolution based on an updated real time eye tracking coordinate detected by the terminal device, thereby generating an updated image; and combining, by the terminal device, the first image having the first resolution and the updated image to generate a composite image.

Optionally, the data streams comprise a first data stream encoding the second image having the second resolution, a second data stream encoding the first image having the first resolution, and a third data stream encoding parameter data.

Optionally, transmitting the data streams from the content server to the terminal device comprises transmitting the first data stream with a first bitrate; transmitting the second data stream with a second bitrate; and transmitting the third data stream with a third bitrate; wherein the third bitrate is higher than the first bitrate; and the first bitrate is higher than the second bitrate.

Optionally, the method further comprises pre-defining, by the content server, a pre-defined high-resolution region; receiving, by the content server, the eye tracking data which includes the eye tracking coordinate detected by the terminal device at a first time point; and calculating, by the content server, a predicted eye tracking coordinate at a second time point.

Optionally, the dynamic high-resolution region is determined based on a width of a pre-defined high-resolution region; a length of the pre-defined high-resolution region; an instantaneous eye movement vector speed of the eye movement at the first time point; an instantaneous eye movement acceleration of the eye movement at the first time point; and a difference between the second time point and the first time point.

Optionally, a difference between the second time point and the first time point is substantially the same as a round-trip time between the content server and the terminal device.

Optionally, the predicted eye tracking coordinate is a central point of the dynamic high-resolution region at the second time point; and the central point, a width, and a length of the dynamic high-resolution region are dynamically changed over time, based on changes of the instantaneous eye movement vector speed and the instantaneous eye movement acceleration over time.

Optionally, the method further comprises frame-synchronizing, by the terminal device, the first data stream encoding the second image having the second resolution, the second data stream encoding the first image having the first resolution, and the third data stream encoding the parameter data.

Optionally, the method further comprises extracting, by the terminal device, a first presentation time stamp from the decoded first data stream; extracting, by the terminal device, a second presentation time stamp from the decoded second data stream; extracting, by the terminal device, a third presentation time stamp from the decoded third data stream; and determining whether the first presentation time stamp, the second presentation time stamp, and the third presentation time stamp are the same.

Optionally, the method further comprises upon determination that the first presentation time stamp is earlier than the second presentation time stamp, discarding a present frame of a decoded first data stream, and awaiting a next frame of the decoded first data stream; or upon determination that the first presentation time stamp is later than the second presentation time stamp, discarding a present frame of a decoded second data stream, and awaiting a next frame of the decoded second data stream.

Optionally, the method further comprises upon determination that the first presentation time stamp is earlier than the third presentation time stamp, discarding the present frame of the decoded first data stream and the present frame of the decoded second data stream, and awaiting a next frame of the decoded first data stream and a next frame of the decoded second data stream; or upon determination that the first presentation time stamp is later than the third presentation time stamp, discarding a present frame of a decoded third data stream, and awaiting a next frame of the decoded third data stream.

Optionally, the method further comprises upon determination that the second presentation time stamp is earlier than the third presentation time stamp, discarding the present frame of the decoded first data stream and the present frame of the decoded second data stream, and awaiting a next frame of the decoded first data stream and a next frame of the decoded second data stream; or upon determination that the second presentation time stamp is later than the third presentation time stamp, discarding a present frame of a decoded third data stream, and awaiting a next frame of the decoded third data stream.

Optionally, the method further comprises generating, by the content server, the parameter data based on the dynamic high-resolution region.

Optionally, transmitting a third data stream encoding the parameter data from the content server to the terminal device comprises transmitting coordinates of a central point of the dynamic high-resolution region; a width of a pre-defined high-resolution region; a length of the pre-defined high-resolution region; a width of the dynamic high-resolution region; a length of the dynamic high-resolution region; and a presentation time stamp.

Optionally, the parameter data is transmitted from the content server to the terminal device using lossless compression.

Optionally, rendering the second image having the second resolution based on the dynamic high-resolution region comprises rendering the second image having the second resolution at least partially based on coordinates of a central point of the dynamic high-resolution region, a width of the dynamic high-resolution region, and a length of the dynamic high-resolution region.

Optionally, rendering the first image having the first resolution comprises performing horizontal compression and performing vertical compression.

In another aspect, the present disclosure provides a display system, comprising a content server and a terminal device; wherein the terminal device is configured to track an eye movement of a user; obtain eye tracking data; transmit the eye tracking data to the content server; wherein the content server is configured to determine a dynamic high-resolution region of an original image based on the eye tracking data; render a first image having a first resolution, wherein the first image is a full low-resolution rendering of the original image; render a second image having a second resolution based on the dynamic high-resolution region, wherein the second image is a high-resolution rendering of a region of the original image; encode the second image having the second resolution, the first image having the first resolution, and parameter data in data streams; and transmit the data streams from the content server to the terminal device for image display; wherein the second resolution is greater than the first resolution.

In another aspect, the present disclosure provides a computer-program product, comprising a non-transitory tangible computer-readable medium having computer-readable instructions thereon, the computer-readable instructions are executable by one or more first processors to cause the one or more first processors to perform tracking an eye movement of a user and obtaining eye tracking data; and transmitting the eye tracking data from the terminal device to a content server; the computer-readable instructions are executable by one or more second processors to cause the one or more second processors to perform determining a dynamic high-resolution region of an original image based on the eye tracking data; rendering a first image having a first resolution, wherein the first image is a full low-resolution rendering of the original image; rendering a second image having a second resolution based on the dynamic high-resolution region, wherein the second image is a high-resolution rendering of a region of the original image; encoding the second image having the second resolution, the first image having the first resolution, and parameter data in data streams; and transmitting the data streams from a content server to a terminal device for image display; wherein the second resolution is greater than the first resolution.

### BRIEF DESCRIPTION OF THE FIGURES

The following drawings are merely examples for illustrative purposes according to various disclosed embodiments and are not intended to limit the scope of the present invention.

FIG. 1 is a flow chat illustrating a method of image display in some embodiments according to the present disclosure.

FIG. 2 is a schematic diagram illustrating a display system implementing a method of image display in some embodiments according to the present disclosure.

FIG. 3 is a flow chart illustrating a process of frame-synchronizing the first data stream encoding the second image having the second resolution, the second data stream encoding the first image having the first resolution, and the third data stream encoding the parameter data in some embodiments according to the present disclosure.

FIG. 4 is a flow chart illustrating a process of frame-synchronizing the first data stream encoding the second image having the second resolution, the second data stream encoding the first image having the first resolution, and the third data stream encoding the parameter data in some embodiments according to the present disclosure.

FIG. 5 illustrates a process of rendering a second image having a second resolution and a first image having a first resolution in some embodiments according to the present disclosure.

FIG. 6 illustrates a process of cropping a second image having a second resolution based on an updated real time eye tracking coordinate for generating an updated image in some embodiments according to the present disclosure.

FIG. 7 is a schematic diagram illustrating a terminal device in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

A user can use a head-mount device (HMD) to view virtual reality contents, for example, contents stored on a cloud server. Compared to locally storing a vast amount of virtual reality content resources, storing the contents on the cloud can reduce the performance requirements on the client side. However, the transmission of VR content over the internet faces challenges such as bandwidth limitations and latency.

Accordingly, the present disclosure provides, inter alia, a method of image display and a display system that substantially obviate one or more of the problems due to limitations and disadvantages of the related art. In one aspect, the present disclosure provides a method of image display. In some embodiments, the method of image display includes tracking, by a terminal device, an eye movement of a user and obtaining eye tracking data: transmitting the eye tracking data from the terminal device to a content server; determining, by the content server, a dynamic high-resolution region of an original image based on the eye tracking data; rendering, by the content server, a first image having a first resolution, wherein the first image is a full low-resolution rendering of the original image; rendering, by the content server, a second image having a second resolution based on the dynamic high-resolution region, wherein the second image is a high-resolution rendering of a region of the original image; encoding, by the content server, the first image having the first resolution, the second image having the second resolution, and parameter data in data streams; and transmitting the data streams from the content server to the terminal device for image display. The second resolution is greater than the first resolution. Optionally, the first image is a full low-resolution image; the second image is a high-resolution image; and a resolution of the high-resolution image is greater than a resolution of the full low-resolution image.

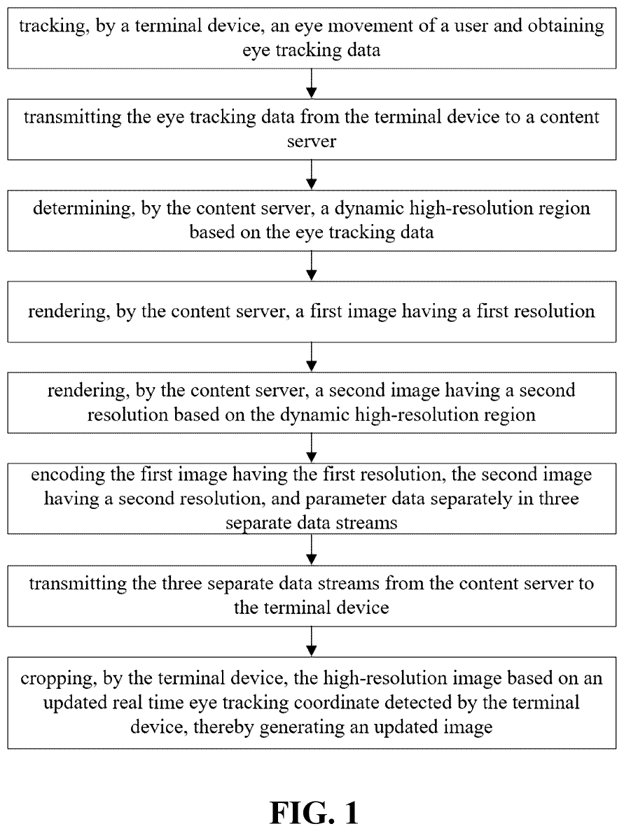

FIG. 1 is a flow chat illustrating a method of image display in some embodiments according to the present disclosure. Referring to FIG. 1, the method of image display in some embodiments includes tracking, by a terminal device, an eye movement of a user and obtaining eye tracking data; transmitting the eye tracking data from the terminal device to a content server; determining, by the content server, a dynamic high-resolution region based on the eye tracking data; rendering, by the content server, a first image having a first resolution; rendering, by the content server, a second image having a second resolution based on the dynamic high-resolution region; encoding the second image having the second resolution, the first image having the first resolution, and parameter data separately in three separate data streams; transmitting the three separate data streams from the content server to the terminal device; and cropping, by the terminal device, the second image having the second resolution based on an updated real time eye tracking coordinate detected by the terminal device, thereby generating an updated image. Optionally, the second resolution is greater than the first resolution.

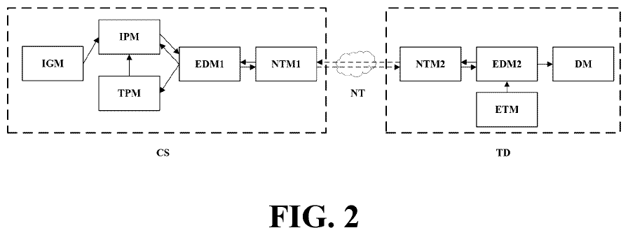

FIG. 2 is a schematic diagram illustrating a display system implementing a method of image display in some embodiments according to the present disclosure. Referring to FIG. 1 and FIG. 2, the display system implementing the method of image display in some embodiments includes a content server CS and a terminal device TD. The content server CS and the terminal device are configured to be in communication through a network NT (e.g., internet).

The content server CS is a crucial component in a distributed system responsible for storing and serving content to clients or end-users. It acts as the central repository of data, including files, documents, media, or any other form of information that needs to be accessed or distributed within the system. The content server CS manages the storage, retrieval, and delivery of content efficiently and securely.

The terminal device TD refers to the hardware or interface through which users interact with a system or network. It serves as a gateway for users to access and utilize the functionalities and services provided by the system. Terminal devices can take various forms. Examples of terminal devices include personal computers; mobile devices such as smartphones and tablets; internet of things such as smart TVs, smart speakers, and home automation systems; and virtual reality/augmented reality devices such as head-mounted displays (HMDs) and other immersive devices. Terminal devices typically have software applications or web browsers installed, enabling users to access system services, browse content, perform transactions, or communicate with other users. These devices communicate with servers or backend systems through various protocols, such as HTTP, TCP/IP, or proprietary communication protocols.

Referring to FIG. 2, the content server CS in some embodiments includes an image generating module IGM, an image processing module IPM, a tracking prediction module TPM, a first encoding-decoding module EDM1, and a first network transmission module NTM1. The image processing module IPM is configured to generate an original image (e.g., a video stream) and transmit the original image to the image processing module IPM.

In some embodiments, the first network transmission module NTM1 is configured to receive an eye tracking data from the terminal device TD, and configured to transmit the eye tracking data to the first encoding-decoding module EDM1. The first encoding-decoding module EDM1 is configured to decode the eye tracking data, and transmit the eye tracking data to the image processing module IPM and the tracking prediction module TPM. The first network transmission module NTM1 is configured to determine a round-trip time at the present time. As used herein, the term “round-trip time” refers to the total time it takes for a packet of data to travel from a source to a destination and back again. It is a measure of the latency or delay in the network. To calculate the round-trip time, a device (such as a computer or server) sends a packet of data to a destination, and the destination acknowledges the receipt of the packet by sending it back to the source. The round-trip time is then determined by measuring the time it takes for the packet to travel from the source to the destination and back again.

In some embodiments, the image processing module IPM is configured to render a first image having a first resolution. A first image having a first resolution refers to an image that has been rendered in its entirety but with a low level of detail or resolution. In one example, the image processing module IPM generates a complete image with reduced detail. The first image having the first resolution serves as a foundation on which a subsequent high-definition region is rendered. The inventors of the present disclosure discover that, by having the complete image at a lower resolution, the system can focus computational efforts on generating the high-definition portion only for the specific area that requires more detail. This approach helps optimize network transmission and resource allocation while still providing an acceptable level of visual representation for the user.

In some embodiments, upon receiving the eye tracking data, the tracking prediction module TPM is configured to determine a dynamic high-resolution region based on the eye tracking data. The dynamic high-resolution region refers to a specific region within an image that is rendered with a higher level of detail or resolution compared to the rest of the image. In some embodiments, this region is calculated based on the eye tracking data and is dynamically adjusted as the user's gaze or focus changes. The purpose of the dynamic high-resolution region is to allocate computational resources and network bandwidth efficiently. Instead of rendering the entire image at high resolution, which would require significant computational power and transmission capacity, the system focuses on rendering only the specific region that corresponds to where the user is looking. By utilizing eye tracking data, the system can determine the user's point of interest or gaze and dynamically adjust the high-resolution rendering accordingly. This ensures that the region the user is actively looking at appears sharp and detailed while the remaining areas can be rendered at a lower resolution to conserve resources. The inventors of the present disclosure discover that, this dynamic approach allows for a more efficient allocation of computational resources, reduces network bandwidth requirements, and provides an enhanced visual experience for the user by prioritizing the rendering of the important regions in high detail.

In some embodiments, the tracking prediction module TPM is further configured to generate parameter data based on the dynamic high-resolution region. In some embodiments, the parameter data includes specific configuration settings that apply only to the dynamic high-resolution region. These settings can control aspects such as image processing algorithms, rendering techniques, or quality parameters tailored specifically for the dynamic high-resolution region. In some embodiment, the parameter data further includes data that provides additional descriptive information about the dynamic high-resolution region. This parameter data can include attributes such as the size or dimensions of the dynamic high-resolution region, its position within the image, or any other relevant characteristics. In some embodiment, the parameter data further includes time stamp information. The time stamp information provides timing or temporal data associated with the dynamic high-resolution region. It helps in synchronizing and coordinating actions or processes related to the high-resolution rendering and ensures proper alignment with other components or systems. By including time stamp information in the parameter data, the system can accurately track and manage the timing aspects of the dynamic high-resolution region. This information can be used for synchronization purposes, data coordination, or to ensure that the high-resolution rendering is properly aligned with other visual or interactive elements in the system.

In some embodiments, the image processing module IPM is configured to render a second image having a second resolution based on the dynamic high-resolution region. The image processing module IPM utilizes various image processing techniques, algorithms, and computational resources to render the second image having the second resolution. It focuses its rendering efforts on the dynamic high-resolution region, ensuring that this specific area appears with enhanced detail, clarity, and visual fidelity. The inventors of the present disclosure discover that, by rendering the second image having the second resolution selectively for the dynamic high-resolution region, the image processing module IPM optimizes computational resources and reduces processing overhead. Instead of rendering the entire image at high resolution, which can be computationally expensive, the image processing module IPM prioritizes the area that requires more detail based on the dynamic high-resolution region. The second image having the second resolution generated by the IPM can be further utilized for subsequent processes such as encoding, compression, or transmission. It forms part of the overall image representation that is ultimately transmitted to the display end for viewing by the user.

In some embodiments, the first encoding-decoding module EDM1 is configured to encode the second image having the second resolution, the first image having the first resolution, and the parameter data separately in three separate data streams, including a first data stream encoding the second image having the second resolution, a second data stream encoding the first image having the first resolution, and a third data stream encoding the parameter data. Optionally, the first data stream, the second data stream, and the third data stream have different bit rates.

In some embodiments, the first network transmission module NTM1 is configured to transmit the three separate data streams to the terminal device TD, e.g., transmit the three separate data streams to a second network transmission module NTM2 in the terminal device TD. Optionally, the first network transmission module NTM1 is configured to transmit the three separate data streams to the second network transmission module NTM2 through Web Real-Time Communications (WebRTC).

The inventors of the present disclosure discover that, the latency exists during transmission of the eye tracking data from the terminal device TD to the content server CS, and the latency exists during transmission of the second image having the second resolution from the content server CS to the terminal device TD. In public network transmission, network latency can vary due to the user locations, different telecommunications broadband providers, and varying network access times (such as during low or peak network usage periods). Therefore, network latency can be relatively high and sometimes exceed 100 milliseconds, during which time significant changes in eye position may occur, which introduces significant errors.

In the present disclosure, eye tracking data is transmitted to the content server for predicting the eye coordinates. Moreover, the present disclosure determines a dynamic high-resolution region to ensure that a dynamically expanded and enlarged the high-resolution region would cover the changes in the high-definition gaze area caused by eye movement during transmission, thus preventing any overflow of the high-definition gaze area. In one example, a dynamic high-resolution region can be a dynamic high-resolution extended region.

Referring to FIG. 2, the terminal device TD in some embodiments includes a second network transmission module NTM2, a second encoding-decoding module EDM2, an eye tracking module ETM, and a display module DM. The second network transmission module NTM2 is configured to receive the three separate data streams from the first network transmission module NTM1. The second encoding-decoding module EDM2 is configured to decode the three separate data streams. Optionally, the second encoding-decoding module EDM2 is configured to decode each of the three separate data streams separately to extract corresponding data. Once the second encoding-decoding module EDM2 has successfully received and extracted the data from the three streams, further processing can take place. This may involve combining the high-definition and low-definition data, applying any necessary image processing based on the information stream, or any other operations required to generate the final image for display or further usage.

In some embodiments, the display module DM is configured to crop the second image having the second resolution based on an updated real time eye tracking coordinate detected by the eye tracking module ETM, thereby generating an updated image. The updated real time eye tracking coordinate helps determine the specific area of interest.

In some embodiments, the display module DM is configured to combine the updated image with the first image having the first resolution. Optionally, the combining process involves combining the updated image with a corresponding portion of the first image having the first resolution to generate a composite image.

In some embodiments, the eye tracking module ETM is configured to track an eye movement of a user and obtaining eye tracking data. Optionally, the second encoding-decoding module EDM2 is configured to encode the eye tracking data and transmit the eye tracking data to the second network transmission module NTM2. Optionally, the second network transmission module NTM2 is configured to transmit the eye tracking data to the first network transmission module NTM1.

In some embodiments, the eye tracking module ETM is further configured to obtain the updated real time eye tracking coordinate, and configured to transmit the updated real time eye tracking coordinate to the second encoding-decoding module EDM2. Optionally, the second encoding-decoding module EDM2 is configured to transmit the updated real time eye tracking coordinate to the display module DM. In alternative embodiments, the eye tracking module ETM is configured to directly transmit the updated real time eye tracking coordinate to the display module DM.

In some embodiments, the eye tracking data includes eye tracking coordinate at a time the eye tracking module ETM is configured to track the eye movement of the user. The eye tracking coordinate refers to, for example, gaze coordinates of eyeballs of the user. The eye tracking coordinate is transmitted to the content server for determining the dynamic high-resolution region. The eye tracking coordinate is compared to the updated real time eye tracking coordinate when the terminal device is configured to crop the second image having the second resolution based on the updated real time eye tracking coordinate. In some embodiments, the eye tracking data includes instantaneous eye movement vector speed and instantaneous eye movement acceleration. The term “instantaneous eye movement vector speed” refers to the speed or velocity of the eye movement at a particular moment in time. It represents the rate at which the eye is moving in a specific direction at that instant. The term “instantaneous eye movement acceleration” refers to the acceleration of the eye movement at a particular moment in time. Acceleration refers to the rate of change of velocity, it represents how quickly the eye's movement speed is changing at a particular moment.

In some embodiments, determining the dynamic high-resolution region includes determining a first pre-defined high-resolution region based on the eye tracking coordinate detected at the first time point; calculating a predicted eye tracking coordinate at the second time point based on the instantaneous eye movement vector speed of the eye movement at the first time point and the instantaneous eye movement acceleration of the eye movement at the first time point; and determining a second pre-defined high-resolution region based on the predicted eye tracking coordinate at the second time point. Optionally, the first pre-defined high-resolution region and the second pre-defined high-resolution region have a same width and a same length, but different central points. The dynamic high-resolution region is a region that encompasses both the first pre-defined high-resolution region and the second pre-defined high-resolution region.

Accordingly, the method of image display in some embodiments includes tracking, by a terminal device, an eye movement of a user and obtaining eye tracking data; encoding, by the terminal device, the eye tracking data; and transmitting, by the terminal device, the eye tracking data, to a content server.

In some embodiments, the method further includes receiving, by the content server, the eye tracking data from the terminal device; and decoding, by the content server, the eye tracking data. Optionally, the method further includes determining, by the content server, a round-trip time at the present time.

In some embodiments, the method further includes rendering, by the content server, a first image having a first resolution.

In some embodiments, the method further includes determining a dynamic high-resolution region based on the eye tracking data; and rendering, by the content server, a second image having a second resolution based on the dynamic high-resolution region.

In some embodiments, the method further includes generating, by the content server, parameter data based on the dynamic high-resolution region.

In some embodiments, the method further includes encoding, by the content server, the second image having the second resolution, the first image having the first resolution, and the parameter data separately in three separate data streams, including a first data stream encoding the second image having the second resolution, a second data stream encoding the first image having the first resolution, and a third data stream encoding the parameter data. Optionally, the first data stream, the second data stream, and the third data stream have different bit rates.

In related methods of image display and display systems, there is only one transmission stream for a single video. The present disclosure divides the single video into three separate data streams: the first data stream encoding the second image having the second resolution, the second data stream encoding the first image having the first resolution, and the third data stream encoding the parameter data, surprisingly and unexpectedly achieving low-latency real-time communications transmission protocol. The present disclosure allows for different compression rates for the three separate data streams, ensuring clear image quality while reducing the bitrate.

In some embodiments, the first data stream encoding the second image having the second resolution is transmitted with a higher bitrate to prioritize image quality, the second data stream encoding the first image having the first resolution is transmitted with a low bitrate. The first image having the first resolution undergoes pixel compression during the rendering process and is further compressed with a low bitrate encoding to reduce the amount of transmitted data. In one example, the third data stream encoding the parameter data is not compressed. The inventors of the present disclosure discover that, by employing the three-stream real-time communications transmission protocol, the present disclosure achieves compression and transmission of the three different bitrates mentioned above.

In some embodiments, the method further includes transmitting, by the content server, the three separate data streams to the terminal device.

In some embodiments, the method further includes decoding, by the terminal device, the three separate data streams.

In some embodiments, the method further includes obtaining, by the terminal device, the updated real time eye tracking coordinate.

In some embodiments, the method further includes cropping, by the terminal device, the second image having the second resolution based on the updated real time eye tracking coordinate, thereby generating an updated image.

In some embodiments, the method further includes combining, by the terminal device, the updated image with the first image having the first resolution, thereby generating a composite image.

In some embodiments, the method further includes displaying, by the terminal device, the composite image.

As discussed above, the method in some embodiments includes determining, by the content server, a round-trip time at the present time. Optionally, the round-trip time is determined periodically, e.g., by the content server. The content server in addition is configured to receive the eye tracking data which includes the eye tracking coordinate detected at a first time point t1. The eye tracking coordinate may be represented by (x, y). The method in some embodiments further includes calculating, by the content server, a predicted eye tracking coordinate (x′, y′) at a second time point t2, wherein t2−t1=Δt. In one example, a difference Δt between the second time point t2 and the first time point t1 is substantially the same as the round-trip time. As used herein, the term “substantially the same” refers to a difference between two values not exceeding 10% of a base value (e.g., one of the two values), e.g., not exceeding 8%, not exceeding 6%, not exceeding 4%, not exceeding 2%, not exceeding 1%, not exceeding 0.5%, not exceeding 0.1%, not exceeding 0.05%, and not exceeding 0.01%, of the base value. As discussed above, in some embodiments, the eye tracking data further includes an instantaneous eye movement vector speed v and an instantaneous eye movement acceleration a. In some embodiments, the method predefines a width w and a length h of a pre-defined high-resolution region.

In some embodiments, the method includes determining, by the content server, the dynamic high-resolution region based on (w, h, v, a, Δt), wherein w stands for a width of a pre-defined high-resolution region, h stands for a length of the pre-defined high-resolution region, v stands for an instantaneous eye movement vector speed of the eye movement at a first time point, a stands for an instantaneous eye movement acceleration of the eye movement at the first time point, and Δt stands for a difference between a second time point and the first time point. Optionally, the difference Δt between the second time point and the first time point is substantially the same as a round-trip time between the content server and the terminal device.

In some embodiments, the method includes determining a central point (x′, y′), a width w′, and a length h′ of the dynamic high-resolution region based on the (w, h, v, a, Δt). Optionally, the central point (x′, y′), the width w′, and the length h′ of the dynamic high-resolution region are dynamically changed over time, based on changes of the instantaneous eye movement vector speed v and the instantaneous eye movement acceleration a over time. The dynamically expanded and enlarged the high-resolution region according to the present disclosure would cover the changes in the high-definition gaze area caused by eye movement during transmission, thus preventing any overflow of the high-definition gaze area, and minimizing the data volume of the high-definition region as much as possible.

In some embodiments, the method further includes frame-synchronizing the first data stream encoding the second image having the second resolution, the second data stream encoding the first image having the first resolution, and the third data stream encoding the parameter data. The term frame synchronizing refers to a process of aligning the frames or video sequences from different sources so that they can be displayed or processed together in a synchronized manner. It involves matching the timing and sequence of frames between multiple video streams to ensure proper playback or further processing. The inventors of the present disclosure discover that frame synchronizing is necessary to ensure that the first data stream encoding the second image having the second resolution, the second data stream encoding the first image having the first resolution, and the third data stream encoding the parameter data are played or processed together in perfect synchronization. The time stamp information, such as the presentation time stamp (PTS), is used to accurately align and synchronize the frames of these streams at the display end, ensuring that the visual and control parameters are properly coordinated and displayed without any noticeable discrepancies or timing issues.

In some embodiments, during the process of encoding the second image having the second resolution, the first image having the first resolution, and the parameter data separately into the first data stream encoding the second image having the second resolution, the second data stream encoding the first image having the first resolution, and the third data stream encoding the parameter data, respectively, the time stamp for the third data stream is extracted from the presentation time stamp (PTS) of the first data stream and/or the second data stream.

Presentation time stamp (PTS) is a time stamp associated with each frame or packet in a video or audio stream. It represents the intended presentation time of the frame or packet in the media playback timeline. The PTS provides a reference for the decoder or renderer to synchronize the frames correctly for smooth and accurate playback. The PTS is typically measured in units of time, such as milliseconds or microseconds, and is used to determine the order in which frames should be displayed or processed. By comparing the PTS of each frame, the playback system can ensure that frames are rendered or played back in the correct sequence and at the intended timing, maintaining the temporal coherence and smoothness of the media presentation.

In some embodiments, the parameter data includes (x′, y′, w, h, w′, h′, pts), wherein x′ and y′ stand for coordinates of a central point of the dynamic high-resolution region, w stands for a width of a pre-defined high-resolution region, h stands for a length of the pre-defined high-resolution region, w′ stands for a width of the dynamic high-resolution region, h′ stands for a length of the dynamic high-resolution region, and pts stands for presentation time stamp. In some embodiments, encoding the parameter data includes encoding (x′, y′, w, h, w′, h′, pts). In some embodiments, the method includes transmitting encoded (x′, y′, w, h, w′, h′, pts) from the content server to the terminal device. In one example, the encoded (x′, y′, w, h, w′, h′, pts) is transmitted using lossless compression (h265-lossless). The inventors of the present disclosure discover that it is advantages to use the lossless compression because the parameter data includes control parameters that require precision. Because the third data stream has a relatively small data volume, it demands negligible bandwidth resources.

In some embodiments, rendering the second image having the second resolution based on the dynamic high-resolution region includes rendering the second image having the second resolution at least partially based on (x′, y′, w′, h′), wherein x′ and y′ stand for coordinates of a central point of the dynamic high-resolution region, w′ stands for a width of the dynamic high-resolution region, and h′ stands for a length of the dynamic high-resolution region. The second image having the second resolution is rendered to have a central point at (x′, y′), a width of x′, and a length of y′. Compared to rendering a full high-resolution image, rendering pressure and data volume are much reduced when a second image having a second resolution is rendered in a region corresponding to the dynamic high-resolution region. In one example, once the rendering is complete, the second image having the second resolution will undergo high-bitrate compression encoding (h265-cbr) and be transmitted over the network as the first data stream to the terminal device. The second image having the second resolution is compressed at a high bitrate, resulting in a larger data volume compared to low-bitrate encoding methods. However, it significantly enhances the image quality. Since it is a locally high-definition region and the data volume is relatively smaller compared to the full high-resolution image, it ensures both image quality and reduces the bandwidth requirements for transmission.

In some embodiments, rendering the first image having the first resolution includes performing horizontal compression and performing vertical compression. Horizontal compression refers to the process of reducing the number of pixels or adjusting the width of an image in the horizontal direction. It involves compressing the image horizontally by combining adjacent pixels or reducing the resolution in the horizontal plane. This compression technique can reduce the file size or data volume of an image, making it more efficient for storage or transmission. Vertical compression, on the other hand, refers to the process of reducing the number of pixels or adjusting the height of an image in the vertical direction. It involves compressing the image vertically by combining adjacent pixels or reducing the resolution in the vertical plane. This compression technique can also reduce the file size or data volume of an image, making it more efficient for storage or transmission. In one example, the first image having the first resolution has a width w″ and a length h″.

In one example, the first image having the first resolution is encoded using a low-bitrate compression (h265-cbr) and be transmitted over the network as the second data stream to the terminal device. Because the user does not have strict image quality requirements for the low-resolution region, this low-bitrate compression specifically targeting the low-resolution region significantly reduces the network bandwidth required for transmission.

The present disclosure utilizes a low-latency real-time communications protocol for transmitting data streams. However, the low-latency real-time communications protocol may encounter issues with packet loss during transmission. If only a single data stream is used, the loss of a data packet would, at most, affect the frame associated with the lost packet, with minimal impact on subsequent display. However, with the adoption of the three-way stream splitting approach, data stream synchronization becomes a concern. In some embodiments, a synchronization process is implemented at the terminal device when receiving the separate three separate data streams.

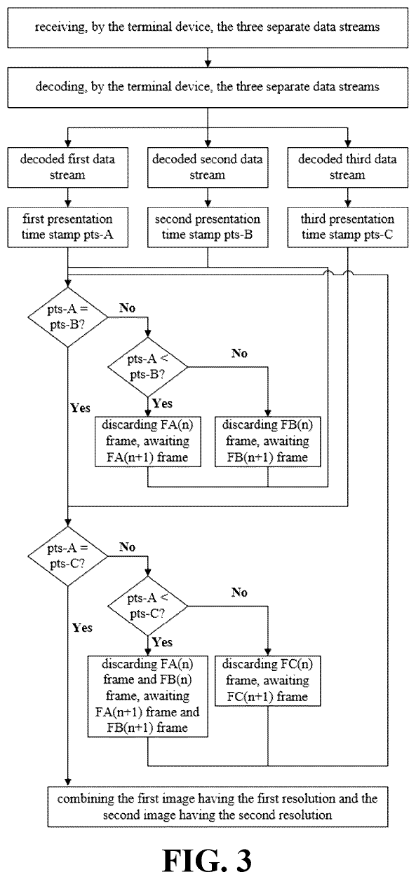

FIG. 3 is a flow chart illustrating a process of frame-synchronizing the first data stream encoding the second image having the second resolution, the second data stream encoding the first image having the first resolution, and the third data stream encoding the parameter data in some embodiments according to the present disclosure. Referring to FIG. 3, the method includes receiving, by the terminal device, the three separate data streams, and decoding, by the terminal device, the three separate data streams. Subsequent to the decoding, a decoded first data stream, a decoded second data stream, and a decoded third data stream are obtained. In some embodiments, the method further includes extracting, by the terminal device, a first presentation time stamp pts-A from the decoded first data stream, extracting, by the terminal device, a second presentation time stamp pts-B from the decoded second data stream, and extracting, by the terminal device, a third presentation time stamp pts-C from the decoded third data stream.

In some embodiments, the method further includes determining whether the first presentation time stamp pts-A is the same as the second presentation time stamp pts-B. Upon determination that the first presentation time stamp pts-A is the same as the second presentation time stamp pts-B, the method further includes determining whether the first presentation time stamp pts-A is the same as the third presentation time stamp pts-C. Upon determination that the first presentation time stamp pts-A is the same as the second presentation time stamp pts-B, and the first presentation time stamp pts-A is the same as the third presentation time stamp pts-C, the method includes combining the second image having the second resolution and the first image having the first resolution.

Upon determination that the first presentation time stamp pts-A is different from the second presentation time stamp pts-B, the method further includes determining whether the first presentation time stamp pts-A is earlier than the second presentation time stamp pts-B. If the first presentation time stamp pts-A is earlier than the second presentation time stamp pts-B, it indicates a frame loss occurs in the second data stream. Upon determination that the first presentation time stamp pts-A is earlier than the second presentation time stamp pts-B, the method further includes discarding a present frame FA(n) of the decoded first data stream, and awaiting a next frame FA(n+1) of the decoded first data stream.

If the first presentation time stamp pts-A is later than the second presentation time stamp pts-B, it indicates a frame loss occurs in the first data stream. Upon determination that the first presentation time stamp pts-A is later than the second presentation time stamp pts-B, the method further includes discarding a present frame FB(n) of the decoded second data stream, and awaiting a next frame FB(n+1) of the decoded second data stream.

The processes are reiterated until it is determined that the first presentation time stamp pts-A is the same as the second presentation time stamp pts-B, indicating the decoded first data stream and the decoded second data stream have been frame synchronized.

Upon determination that the first presentation time stamp pts-A is the same as the second presentation time stamp pts-B, the method further includes determining whether the first presentation time stamp pts-A is the same as the third presentation time stamp pts-C. Upon determination that the first presentation time stamp pts-A is the same as the second presentation time stamp pts-B, and the first presentation time stamp pts-A is the same as the third presentation time stamp pts-C, the method includes combining the second image having the second resolution and the first image having the first resolution.

Upon determination that the first presentation time stamp pts-A is different from the third presentation time stamp pts-C, the method further includes determining whether the first presentation time stamp pts-A is earlier than the third presentation time stamp pts-C. If the first presentation time stamp pts-A is earlier than the third presentation time stamp pts-C, it indicates a frame loss occurs in the third data stream. Upon determination that the first presentation time stamp pts-A is earlier than the third presentation time stamp pts-C, the method further includes discarding a present frame FA(n) of the decoded first data stream and a present frame FB(n) of the decoded second data stream, and awaiting a next frame FA(n+1) of the decoded first data stream and a next frame FB(n+1) of the decoded second data stream.

If the first presentation time stamp pts-A is later than the third presentation time stamp pts-C, it indicates a frame loss occurs in the first data stream and a frame loss occurs in the second data stream. Upon determination that the first presentation time stamp pts-A is later than the third presentation time stamp pts-C, the method further includes discarding a present frame FC(n) of the decoded third data stream, and awaiting a next frame FC(n+1) of the decoded third data stream.

The processes are reiterated until it is determined that the first presentation time stamp pts-A is the same as the second presentation time stamp pts-B, and is the same as the third presentation time stamp pts-C, indicating the decoded first data stream, the decoded second data stream, and the decoded third data stream have been frame synchronized.

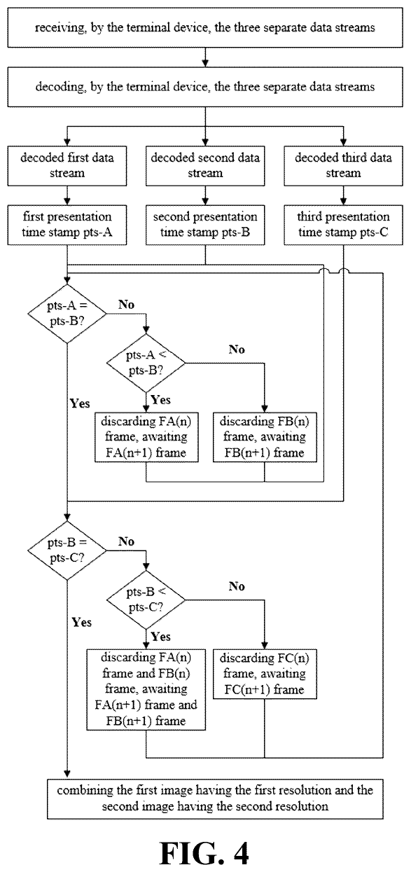

FIG. 4 is a flow chart illustrating a process of frame-synchronizing the first data stream encoding the second image having the second resolution, the second data stream encoding the first image having the first resolution, and the third data stream encoding the parameter data in some embodiments according to the present disclosure. Referring to FIG. 4, the method includes receiving, by the terminal device, the three separate data streams, and decoding, by the terminal device, the three separate data streams. Subsequent to the decoding, a decoded first data stream, a decoded second data stream, and a decoded third data stream are obtained. In some embodiments, the method further includes extracting a first presentation time stamp pts-A from the decoded first data stream, extracting a second presentation time stamp pts-B from the decoded second data stream, and extracting a third presentation time stamp pts-C from the decoded third data stream.

In some embodiments, the method further includes determining whether the first presentation time stamp pts-A is the same as the second presentation time stamp pts-B. Upon determination that the first presentation time stamp pts-A is the same as the second presentation time stamp pts-B, the method further includes determining whether the second presentation time stamp pts-B is the same as the third presentation time stamp pts-C. Upon determination that the first presentation time stamp pts-A is the same as the second presentation time stamp pts-B, and the second presentation time stamp pts-B is the same as the third presentation time stamp pts-C, the method includes combining the second image having the second resolution and the first image having the first resolution.

Upon determination that the first presentation time stamp pts-A is different from the second presentation time stamp pts-B, the method further includes determining whether the first presentation time stamp pts-A is earlier than the second presentation time stamp pts-B. If the first presentation time stamp pts-A is earlier than the second presentation time stamp pts-B, it indicates a frame loss occurs in the second data stream. Upon determination that the first presentation time stamp pts-A is earlier than the second presentation time stamp pts-B, the method further includes discarding a present frame FA(n) of the decoded first data stream, and awaiting a next frame FA(n+1) of the decoded first data stream.

If the first presentation time stamp pts-A is later than the second presentation time stamp pts-B, it indicates a frame loss occurs in the first data stream. Upon determination that the first presentation time stamp pts-A is later than the second presentation time stamp pts-B, the method further includes discarding a present frame FB(n) of the decoded second data stream, and awaiting a next frame FB(n+1) of the decoded second data stream.

The processes are reiterated until it is determined that the first presentation time stamp pts-A is the same as the second presentation time stamp pts-B, indicating the decoded first data stream and the decoded second data stream have been frame synchronized.

Upon determination that the first presentation time stamp pts-A is the same as the second presentation time stamp pts-B, the method further includes determining whether the second presentation time stamp pts-B is the same as the third presentation time stamp pts-C. Upon determination that the first presentation time stamp pts-A is the same as the second presentation time stamp pts-B, and the second presentation time stamp pts-B is the same as the third presentation time stamp pts-C, the method includes combining the second image having the second resolution and the first image having the first resolution.

Upon determination that the second presentation time stamp pts-B is different from the third presentation time stamp pts-C, the method further includes determining whether the second presentation time stamp pts-B is earlier than the third presentation time stamp pts-C. If the second presentation time stamp pts-B is earlier than the third presentation time stamp pts-C, it indicates a frame loss occurs in the third data stream. Upon determination that the second presentation time stamp pts-B is earlier than the third presentation time stamp pts-C, the method further includes discarding a present frame FA(n) of the decoded first data stream and a present frame FB(n) of the decoded second data stream, and awaiting a next frame FA(n+1) of the decoded first data stream and a next frame FB(n+1) of the decoded second data stream.

If the second presentation time stamp pts-B is later than the third presentation time stamp pts-C, it indicates a frame loss occurs in the first data stream and a frame loss occurs in the second data stream. Upon determination that the second presentation time stamp pts-B is later than the third presentation time stamp pts-C, the method further includes discarding a present frame FC(n) of the decoded third data stream, and awaiting a next frame FC(n+1) of the decoded third data stream.

The processes are reiterated until it is determined that the first presentation time stamp pts-A is the same as the second presentation time stamp pts-B, and is the same as the third presentation time stamp pts-C, indicating the decoded first data stream, the decoded second data stream, and the decoded third data stream have been frame synchronized.

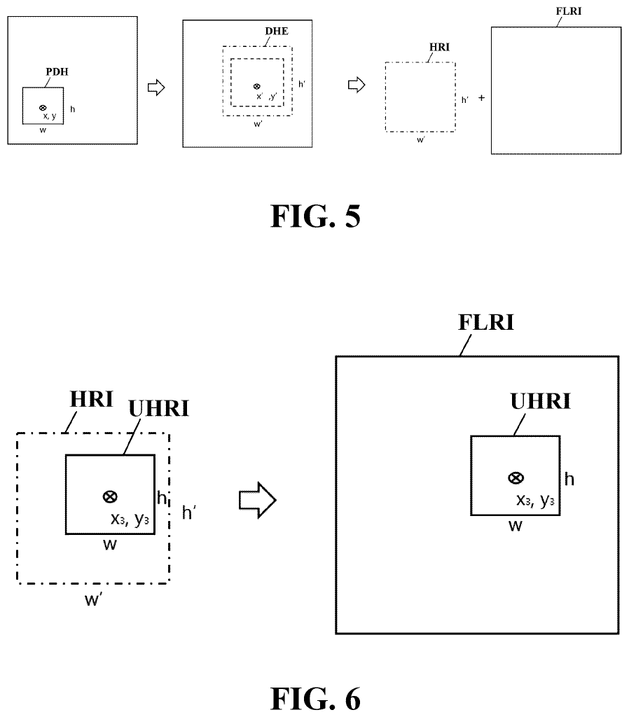

FIG. 5 illustrates a process of rendering a second image having a second resolution and a first image having a first resolution in some embodiments according to the present disclosure. Referring to FIG. 5, Referring to FIG. 5, In some embodiments, the method includes predefining a pre-defined high-resolution region PDH having a width w and a length h. A central point of the pre-defined high-resolution region PDH is defined by the eye tracking coordinate detected at a first time point t1. The method in some embodiments further includes calculating, by the content server, a predicted eye tracking coordinate (x′, y′) at a second time point t2, wherein t2−t1=Δt.

In some embodiments, the method includes determining a central point (x′, y′), a width w′, and a length h′ of the dynamic high-resolution region DHE based on the (w, h, v, a, Δt), wherein w stands for a width of a pre-defined high-resolution region PDH, h stands for a length of the pre-defined high-resolution region PDH, v stands for an instantaneous eye movement vector speed of the eye movement at a first time point, a stands for an instantaneous eye movement acceleration of the eye movement at the first time point, and Δt stands for a difference between a second time point and the first time point. Optionally, the difference Δt between the second time point and the first time point is substantially the same as a round-trip time between the content server and the terminal device. In some embodiments, four vertex coordinates of the dynamically extended high-resolution region DHE can be expressed as (x′−w′/2, y′−h′/2), (x′−w′/2, y′+h′/2), (x′+w′/2, y′+h′/2), and (x′+w′/2, y′−h′/2).

In some embodiments, the method further includes rendering a first image having a first resolution FLRI, and rendering a second image having a second resolution HDI based on the dynamic high-resolution region DHE.

FIG. 6 illustrates a process of cropping a second image having a second resolution based on an updated real time eye tracking coordinate for generating an updated image in some embodiments according to the present disclosure. Referring to FIG. 6, the updated real time eye tracking coordinate is denoted as (x3, y3). In some embodiments, based on the parameter data including (x′, y′, w, h, w′, h′), the method further includes cropping the second image having the second resolution HRI to obtain an updated image UHRI, wherein x′ and y′ stand for coordinates of a central point of the dynamic high-resolution region, w stands for a width of a pre-defined high-resolution region, h stands for a length of the pre-defined high-resolution region, w′ stands for a width of the dynamic high-resolution region, and h′ stands for a length of the dynamic high-resolution region. Optionally, four vertex coordinates of the updated image UHRI can be expressed as (x3−w/2, y3−h/2), (x3−w/2, y3+h/2), (x3+w/2, y3+h/2), and (x3+w/2, y3−h/2). Since the dynamic high-resolution region DHE has already been dynamically extended, the dynamic high-resolution region DHE covers and includes a region corresponding to the updated image UHRI. Therefore, the dynamic high-resolution region DHE can be cropped based on the four vertex coordinates of the updated image UHRI to obtain the updated image UHRI. As shown in FIG. 6, the method in some embodiments further includes combining the updated image UHRI and the first image having the first resolution FLRI, thereby generating a composite image.

In some embodiments, combining the updated image UHRI and the first image having the first resolution FLRI includes expands pixels of the first image having the first resolution FLRI and renders the first image having the first resolution FLRI at full resolution; and rendering the updated image UHRI at a position based on the four vertex coordinates of the updated image UHRI.

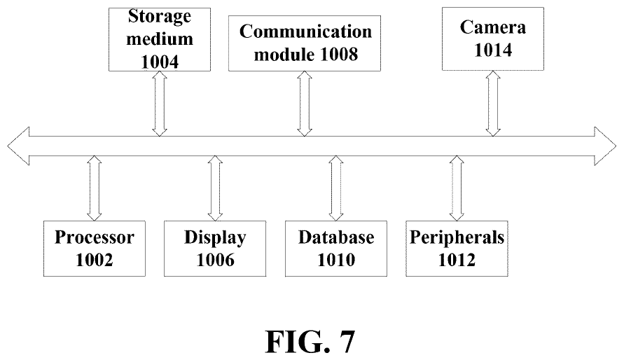

In another aspect, the present disclosure provides a display system. In some embodiments, the display system includes a content server and a terminal device. FIG. 7 is a schematic diagram illustrating a terminal device in some embodiments according to the present disclosure. Referring to FIG. 7, the terminal device in some embodiments includes a processor 1002, a storage medium 1004, a display 1006, a communication module 1008, a database 1010, peripherals 1012, and a camera 1014. Certain devices may be omitted, and other devices may be included to better describe the relevant embodiments. The terminal device may include any appropriate type of display panels, such as a plasma display panel, a liquid crystal display (LCD) panel, a touch screen display panel, a projection display panel, a non-smart display panel, a smart display panel, etc. The terminal device may also include other computing systems, such as a personal computer (PC), a tablet or mobile computer, or a smart phone, etc. In addition, the terminal device may be any appropriate content-presentation device capable of presenting any appropriate content. Users may interact with the terminal device to perform other activities of interest.

The processor 1002 may include any appropriate processor or processors. Further, the processor 1002 may include multiple cores for multi-thread or parallel processing. The processor 1002 may execute sequences of computer program instructions to perform various processes. The storage medium 1004 may include memory modules, such as ROM, RAM, flash memory modules, and mass storages, such as CD-ROM and hard disk, etc. The storage medium 1004 may store computer programs for implementing various processes when the computer programs are executed by the processor 1002. For example, the storage medium 1004 may store computer programs for implementing various algorithms when the computer programs are executed by the processor 1002.

Further, the communication module 1008 may include certain network interface devices for establishing connections through communication networks, such as TV cable network, wireless network, internet, etc. The database 1010 may include one or more databases for storing certain data and for performing certain operations on the stored data, such as database searching.

The display 1006 may provide information to users. The display 1006 may include any appropriate type of computer display device or electronic apparatus display such as LCD or OLED based devices. The peripherals 1012 may include various sensors and other I/O devices, such as keyboard and mouse.

Examples of appropriate terminal devices include, but are not limited to, an electronic paper, a mobile phone, a tablet computer, a television, a monitor, a notebook computer, a digital album, a GPS, etc. Optionally, the terminal device is an organic light emitting diode display apparatus. Optionally, the terminal device is a micro light emitting diode display apparatus. Optionally, the terminal device is a mini light emitting diode display apparatus.

In some embodiments, the terminal device includes a display panel; a first memory; and one or more first processors. Optionally, the first memory and the one or more first processors are connected with each other; and the first memory stores computer-executable instructions for controlling the one or more first processors to perform various tasks described herein.

In some embodiments, the content server includes a second memory; and one or more second processors. Optionally, the second memory and the one or more second processors are connected with each other; and the second memory stores computer-executable instructions for controlling the one or more second processors to perform various tasks described herein.

In some embodiments, the terminal device is configured to track an eye movement of a user; obtain eye tracking data: transmit the eye tracking data to the content server. In some embodiments, the content server is configured to determine a dynamic high-resolution region based on the eye tracking data; render a first image having a first resolution; render a second image having a second resolution based on the dynamic high-resolution region; encode the second image having the second resolution, the first image having the first resolution, and parameter data separately in three separate data streams; and transmit the three separate data streams from the content server to the terminal device for image display. Optionally, the second resolution is greater than the first resolution.

In some embodiments, the terminal device is further configured to obtain an updated real time eye tracking coordinate; crop the second image having the second resolution based on an updated real time eye tracking coordinate detected by the terminal device, thereby generating an updated image; and combine the first image having the first resolution and the updated image to generate a composite image.

In some embodiments, the three separate data streams include a first data stream encoding the second image having the second resolution, a second data stream encoding the first image having the first resolution, and a third data stream encoding parameter data.

In some embodiments, the content server is configured to transmit the first data stream with a first bitrate; transmit the second data stream with a second bitrate; and transmit the third data stream with a third bitrate. Optionally, the third bitrate is higher than the first bitrate. Optionally, the first bitrate is higher than the second bitrate.

In some embodiments, the content server is further configured to pre-define a pre-defined high-resolution region; receive the eye tracking data which includes the eye tracking coordinate detected by the terminal device at a first time point; and calculate a predicted eye tracking coordinate at a second time point.

In some embodiments, the content server is configured to determine the dynamic high-resolution region based on a width of a pre-defined high-resolution region; a length of the pre-defined high-resolution region; an instantaneous eye movement vector speed of the eye movement at the first time point; an instantaneous eye movement acceleration of the eye movement at the first time point; and a difference between the second time point and the first time point. Optionally, a difference between the second time point and the first time point is substantially the same as a round-trip time between the content server and the terminal device. Optionally, the predicted eye tracking coordinate is a central point of the dynamic high-resolution region at the second time point. Optionally, the central point, a width, and a length of the dynamic high-resolution region are dynamically changed over time, based on changes of the instantaneous eye movement vector speed and the instantaneous eye movement acceleration over time.

In some embodiments, the terminal device is further configured to frame-synchronize the first data stream encoding the second image having the second resolution, the second data stream encoding the first image having the first resolution, and the third data stream encoding the parameter data.

In some embodiments, the terminal device is further configured to extract a first presentation time stamp from the decoded first data stream; extract a second presentation time stamp from the decoded second data stream; extract a third presentation time stamp from the decoded third data stream; and determine whether the first presentation time stamp, the second presentation time stamp, and the third presentation time stamp are the same.

In some embodiments, the terminal device is further configured to, upon determination that the first presentation time stamp is earlier than the second presentation time stamp, discard a present frame of a decoded first data stream, and await a next frame of the decoded first data stream; or upon determination that the first presentation time stamp is later than the second presentation time stamp, discard a present frame of a decoded second data stream, and await a next frame of the decoded second data stream.

In some embodiments, the terminal device is further configured to, upon determination that the first presentation time stamp is earlier than the third presentation time stamp, discard the present frame of the decoded first data stream and the present frame of the decoded second data stream, and await a next frame of the decoded first data stream and a next frame of the decoded second data stream; or upon determination that the first presentation time stamp is later than the third presentation time stamp, discard a present frame of a decoded third data stream, and await a next frame of the decoded third data stream.

In some embodiments, the terminal device is further configured to, upon determination that the second presentation time stamp is earlier than the third presentation time stamp, discard the present frame of the decoded first data stream and the present frame of the decoded second data stream, and await a next frame of the decoded first data stream and a next frame of the decoded second data stream; or upon determination that the second presentation time stamp is later than the third presentation time stamp, discard a present frame of a decoded third data stream, and await a next frame of the decoded third data stream.

In some embodiments, the content server is configured to generate the parameter data based on the dynamic high-resolution region. Optionally, the parameter data is transmitted from the content server to the terminal device using lossless compression.

In some embodiments, the content server is configured to transmit to the terminal device coordinates of a central point of the dynamic high-resolution region; a width of a pre-defined high-resolution region; a length of the pre-defined high-resolution region; a width of the dynamic high-resolution region; a length of the dynamic high-resolution region; and a presentation time stamp.

In some embodiments, the content server is configured to render the second image having the second resolution at least partially based on coordinates of a central point of the dynamic high-resolution region, a width of the dynamic high-resolution region, and a length of the dynamic high-resolution region.

In some embodiments, the content server is configured to perform horizontal compression and performing vertical compression on the first image having the first resolution.

In some embodiments, the terminal device is further configured to display the composite image.

In another aspect, the present disclosure provides a computer-program product comprising a non-transitory tangible computer-readable medium having computer-readable instructions thereon. In some embodiments, the computer-readable instructions are executable by one or more first processors to cause the one or more first processors to perform tracking an eye movement of a user and obtaining eye tracking data; and transmitting the eye tracking data from the terminal device to a content server. In some embodiments, the computer-readable instructions are executable by one or more second processors to cause the one or more second processors to perform determining a dynamic high-resolution region based on the eye tracking data: rendering a first image having a first resolution: rendering a second image having a second resolution based on the dynamic high-resolution region; encoding the second image having the second resolution, the first image having the first resolution, and parameter data separately in three separate data streams; and transmitting the three separate data streams from a content server to a terminal device for image display. Optionally, the second resolution is greater than the first resolution.

In some embodiments, the computer-readable instructions are executable by one or more first processors to further cause the one or more first processors to perform obtaining an updated real time eye tracking coordinate; cropping the second image having the second resolution based on an updated real time eye tracking coordinate detected by the terminal device, thereby generating an updated image; and combining the first image having the first resolution and the updated image to generate a composite image

In some embodiments, the three separate data streams comprise a first data stream encoding the second image having the second resolution, a second data stream encoding the first image having the first resolution, and a third data stream encoding parameter data.

In some embodiments, the computer-readable instructions are executable by one or more second processors to further cause the one or more second processors to perform transmitting the first data stream with a first bitrate; transmitting the second data stream with a second bitrate; and transmitting the third data stream with a third bitrate. Optionally, the third bitrate is higher than the first bitrate. Optionally, the first bitrate is higher than the second bitrate.

In some embodiments, the computer-readable instructions are executable by one or more second processors to further cause the one or more second processors to perform pre-defining a pre-defined high-resolution region; receiving the eye tracking data which includes the eye tracking coordinate detected by the terminal device at a first time point; and calculating a predicted eye tracking coordinate at a second time point.

In some embodiments, the computer-readable instructions are executable by one or more second processors to further cause the one or more second processors to perform determining the dynamic high-resolution region based on a width of a pre-defined high-resolution region; a length of the pre-defined high-resolution region; an instantaneous eye movement vector speed of the eye movement at the first time point; an instantaneous eye movement acceleration of the eye movement at the first time point; and a difference between the second time point and the first time point. Optionally, a difference between the second time point and the first time point is substantially the same as a round-trip time between the content server and the terminal device.

In some embodiments, the predicted eye tracking coordinate is a central point of the dynamic high-resolution region at the second time point. Optionally, the central point, a width, and a length of the dynamic high-resolution region are dynamically changed over time, based on changes of the instantaneous eye movement vector speed and the instantaneous eye movement acceleration over time.

In some embodiments, the computer-readable instructions are executable by one or more first processors to further cause the one or more first processors to perform frame-synchronizing the first data stream encoding the second image having the second resolution, the second data stream encoding the first image having the first resolution, and the third data stream encoding the parameter data.

In some embodiments, the computer-readable instructions are executable by one or more first processors to further cause the one or more first processors to perform extracting a first presentation time stamp from the decoded first data stream; extracting a second presentation time stamp from the decoded second data stream; extracting a third presentation time stamp from the decoded third data stream; and determining whether the first presentation time stamp, the second presentation time stamp, and the third presentation time stamp are the same.

In some embodiments, the computer-readable instructions are executable by one or more first processors to further cause the one or more first processors to perform upon determination that the first presentation time stamp is earlier than the second presentation time stamp, discarding a present frame of a decoded first data stream, and awaiting a next frame of the decoded first data stream; or upon determination that the first presentation time stamp is later than the second presentation time stamp, discarding a present frame of a decoded second data stream, and awaiting a next frame of the decoded second data stream.

In some embodiments, the computer-readable instructions are executable by one or more first processors to further cause the one or more first processors to perform upon determination that the first presentation time stamp is earlier than the third presentation time stamp, discarding the present frame of the decoded first data stream and the present frame of the decoded second data stream, and awaiting a next frame of the decoded first data stream and a next frame of the decoded second data stream; or upon determination that the first presentation time stamp is later than the third presentation time stamp, discarding a present frame of a decoded third data stream, and awaiting a next frame of the decoded third data stream.

In some embodiments, the computer-readable instructions are executable by one or more first processors to further cause the one or more first processors to perform upon determination that the second presentation time stamp is earlier than the third presentation time stamp, discarding the present frame of the decoded first data stream and the present frame of the decoded second data stream, and awaiting a next frame of the decoded first data stream and a next frame of the decoded second data stream; or upon determination that the second presentation time stamp is later than the third presentation time stamp, discarding a present frame of a decoded third data stream, and awaiting a next frame of the decoded third data stream.

In some embodiments, the computer-readable instructions are executable by one or more second processors to further cause the one or more second processors to perform generating the parameter data based on the dynamic high-resolution region. Optionally, the parameter data is transmitted from the content server to the terminal device using lossless compression.

In some embodiments, the computer-readable instructions are executable by one or more second processors to further cause the one or more second processors to perform transmitting, to a terminal device, coordinates of a central point of the dynamic high-resolution region; a width of a pre-defined high-resolution region; a length of the pre-defined high-resolution region; a width of the dynamic high-resolution region; a length of the dynamic high-resolution region; and a presentation time stamp.

In some embodiments, the computer-readable instructions are executable by one or more second processors to further cause the one or more second processors to perform rendering the second image having the second resolution at least partially based on coordinates of a central point of the dynamic high-resolution region, a width of the dynamic high-resolution region, and a length of the dynamic high-resolution region.

In some embodiments, the computer-readable instructions are executable by one or more second processors to further cause the one or more second processors to perform performing horizontal compression and performing vertical compression on the first image having the first resolution.

In some embodiments, the computer-readable instructions are executable by one or more first processors to further cause the one or more first processors to perform causing a display panel to display the composite image.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A method of image display, comprising:
tracking, by a terminal device, an eye movement of a user and obtaining eye tracking data;
transmitting the eye tracking data from the terminal device to a content server;
determining, by the content server, a dynamic high-resolution region of an original image based on the eye tracking data;
rendering, by the content server, a first image having a first resolution, wherein the first image is a full low-resolution rendering of the original image;
rendering, by the content server, a second image having a second resolution based on the dynamic high-resolution region, wherein the second image is a high-resolution rendering of a region of the original image;
encoding, by the content server, the second image having the second resolution, the first image having the first resolution, and parameter data in data streams; and
transmitting the data streams from the content server to the terminal device for image display;
wherein the second resolution is greater than the first resolution.

2. The method of claim 1, further comprising:
obtaining, by the terminal device, an updated real time eye tracking coordinate;
cropping, by the terminal device, the second image having the second resolution based on an updated real time eye tracking coordinate detected by the terminal device, thereby generating an updated image; and
combining, by the terminal device, the first image having the first resolution and the updated image to generate a composite image.

3. The method of claim 1, wherein the data streams comprise a first data stream encoding the second image having the second resolution, a second data stream encoding the first image having the first resolution, and a third data stream encoding parameter data.

4. The method of claim 3, wherein transmitting the data streams from the content server to the terminal device comprises:
transmitting the first data stream with a first bitrate;
transmitting the second data stream with a second bitrate; and
transmitting the third data stream with a third bitrate;
wherein the third bitrate is higher than the first bitrate; and
the first bitrate is higher than the second bitrate.

5. The method of claim 1, further comprising:
pre-defining, by the content server, a pre-defined high-resolution region;
receiving, by the content server, the eye tracking data which includes the eye tracking coordinate detected by the terminal device at a first time point; and
calculating, by the content server, a predicted eye tracking coordinate at a second time point.

6. The method of claim 5, wherein the dynamic high-resolution region is determined based on:
a width of a pre-defined high-resolution region;
a length of the pre-defined high-resolution region;
an instantaneous eye movement vector speed of the eye movement at the first time point;
an instantaneous eye movement acceleration of the eye movement at the first time point; and
a difference between the second time point and the first time point.

7. The method of claim 5, wherein a difference between the second time point and the first time point is substantially the same as a round-trip time between the content server and the terminal device.

8. The method of claim 5, wherein the predicted eye tracking coordinate is a central point of the dynamic high-resolution region at the second time point; and
the central point, a width, and a length of the dynamic high-resolution region are dynamically changed over time, based on changes of an instantaneous eye movement vector speed and an instantaneous eye movement acceleration over time.

9. The method of claim 3, further comprising frame-synchronizing, by the terminal device, the first data stream encoding the second image having the second resolution, the second data stream encoding the first image having the first resolution, and the third data stream encoding the parameter data.

10. The method of claim 3, further comprising:
extracting, by the terminal device, a first presentation time stamp from a decoded first data stream;
extracting, by the terminal device, a second presentation time stamp from a decoded second data stream;
extracting, by the terminal device, a third presentation time stamp from a decoded third data stream; and
determining whether the first presentation time stamp, the second presentation time stamp, and the third presentation time stamp are the same.

11. The method of claim 10, further comprising:
upon determination that the first presentation time stamp is earlier than the second presentation time stamp, discarding a present frame of a decoded first data stream, and awaiting a next frame of the decoded first data stream; or
upon determination that the first presentation time stamp is later than the second presentation time stamp, discarding a present frame of a decoded second data stream, and awaiting a next frame of the decoded second data stream.

12. The method of claim 11, further comprising:
upon determination that the first presentation time stamp is earlier than the third presentation time stamp, discarding the present frame of the decoded first data stream and the present frame of the decoded second data stream, and awaiting a next frame of the decoded first data stream and a next frame of the decoded second data stream; or
upon determination that the first presentation time stamp is later than the third presentation time stamp, discarding a present frame of a decoded third data stream, and awaiting a next frame of the decoded third data stream.

13. The method of claim 11, further comprising:
upon determination that the second presentation time stamp is earlier than the third presentation time stamp, discarding the present frame of the decoded first data stream and the present frame of the decoded second data stream, and awaiting a next frame of the decoded first data stream and a next frame of the decoded second data stream; or
upon determination that the second presentation time stamp is later than the third presentation time stamp, discarding a present frame of a decoded third data stream, and awaiting a next frame of the decoded third data stream.

14. The method of claim 1, further comprising generating, by the content server, the parameter data based on the dynamic high-resolution region.

15. The method of claim 14, wherein transmitting a third data stream encoding the parameter data from the content server to the terminal device comprises transmitting coordinates of a central point of the dynamic high-resolution region; a width of a pre-defined high-resolution region; a length of the pre-defined high-resolution region; a width of the dynamic high-resolution region; a length of the dynamic high-resolution region; and a presentation time stamp.

16. The method of claim 1, wherein rendering the second image having the second resolution based on the dynamic high-resolution region comprises rendering the second image having the second resolution at least partially based on coordinates of a central point of the dynamic high-resolution region, a width of the dynamic high-resolution region, and a length of the dynamic high-resolution region.

17. The method of claim 1, wherein rendering the first image having the first resolution comprises performing horizontal compression and performing vertical compression.

18. The method of claim 2, wherein the updated real time eye tracking coordinate detected by the terminal device is expressed as (x3, y3);
four vertex coordinates of the updated image are expressed as (x3−w/2, y3−h/2), (x3−w/2, y3+h/2), (x3+w/2, y3+h/2), and (x3+w/2, y3−h/2);
w stands for a width of a pre-defined high-resolution region; and
h stands for a length of the pre-defined high-resolution region.

19. A display system, comprising a content server and a terminal device;
wherein the terminal device is configured to:
track an eye movement of a user;
obtain eye tracking data;
transmit the eye tracking data to the content server;
wherein the content server is configured to:
determine a dynamic high-resolution region of an original image based on the eye tracking data;
render a first image having a first resolution, wherein the first image is a full low-resolution rendering of the original image;
render a second image having a second resolution based on the dynamic high-resolution region, wherein the second image is a high-resolution rendering of a region of the original image;
encode the second image having the second resolution, the first image having the first resolution, and parameter data in data streams; and
transmit the data streams from the content server to the terminal device for image display;
wherein the second resolution is greater than the first resolution.

20. A computer-program product, comprising a non-transitory tangible computer-readable medium having computer-readable instructions thereon,
the computer-readable instructions are executable by one or more first processors to cause one or more first processors to perform:
tracking an eye movement of a user and obtaining eye tracking data; and
transmitting the eye tracking data from a terminal device to a content server;
the computer-readable instructions are executable by one or more second processors to cause one or more second processors to perform:
determining a dynamic high-resolution region of an original image based on the eye tracking data;
rendering a first image having a first resolution, wherein the first image is a full low-resolution rendering of the original image;
rendering a second image having a second resolution based on the dynamic high-resolution region, wherein the second image is a high-resolution rendering of a region of the original image;
encoding the second image having the second resolution, the first image having the first resolution, and parameter data in data streams; and
transmitting the data streams from a content server to a terminal device for image display;
wherein the second resolution is greater than the first resolution.
